(19) United States
(12) Patent Application Publication
(10) Pub. No.: US 2017/0193415 A1
(43) Pub. Date: Jul. 6, 2017

(54) SYSTEM AND METHOD FOR GENERATING QUANTIFIED LEADS

(71) Applicant: To-Scale Software, LLC, Mason, OH (US)

(72) Inventors: Phillip B. Ogilby, Oregonia, OH (US); Justin Ogilby, Cincinnati, OH (US); Aaron Harmon, Riverton, UT (US)

(21) Appl. No.: 15/396,910

(22) Filed: Jan. 3, 2017

Related U.S. Application Data
(60) Provisional application No. 62/274,884, filed on Jan. 5, 2016.

(51) Int. Cl. G06Q 10/06; G06Q 50/08

(52) U.S. Cl. CPC G06Q 10/06313; G06Q 50/08

(57) ABSTRACT

A system receives basic project information for a construction project such as architectural blueprints. A classification UI may be used to associate the project with one or more provisional classifications which identify high level aspects of the project, such as whether the project requires painting, drywall preparation, or the like. A tasking UI may be used to create a set of tasks that must be performed to complete a project takeoff from the basic project information, such as determining square footage of floors and walls, or determining material costs. A project takeoff UI may be used to complete the set of tasks associated with the project by using measuring and drawing tools. A takeoff review UI may be used to make minor revisions and approve or reject a project takeoff. Once approved, the system distributes the project takeoff through a variety of channels.

### PRIORITY

This application is a non-provisional of, and claims the benefit of, U.S. provisional patent application 62/274,884, filed Jan. 5, 2016, the disclosure of which is hereby incorporated by reference in its entirety.

### FIELD

The disclosed technology pertains to a system for generating and utilizing quantified leads from architectural information.

### BACKGROUND

Within the construction industry, general contractors and contractors obtain leads in a variety of ways. In some instances, a contractor may be in contact with a number of architecture professionals, and may regularly contact each professional via telephone to inquire about designs or blueprints that the professional has recently completed or will soon complete. In other instances, a lead generating company may gather information on potential contracting jobs from architects, building suppliers, local administrative bodies, and other contacts. Gathered information may be distributed to paying subscribers via a printed publication or email distribution, or may be sold on a per request basis. In other instances, leads may be posted and shared on social media, geographically sorted classified ads, peer to peer communications, and other similar forms of communication. While many permutations of the various actors and actions above exist, an undercurrent running throughout is that these processes have had drawbacks in that they have been found to result in inconsistent and sporadic availability of project leads for contractors looking for work, as well as a limited availability of other information related to the project lead.

As an example of a drawback of currently used techniques, it is possible that large volumes of information may be available in a printed periodical or email distribution, but the information may be incomplete or be presented in such a way that finding a particular type of project is impossible. For example, one contractor may only take on painting jobs requiring 200 gallons or less of a brand of paint. A given periodical may list square footage of a building, but may fail to provide other key information such as wall height or acceptable material sources that would be necessary for the contractor to determine if the job should be bid on. Another periodical may include full architectural blueprints for one or more jobs, which may require a contractor to search through hundreds of blueprints in order to determine a handful of pages that are relevant to their work. Accordingly, identifying and generating project leads can be a major inefficiency for a contractor regardless of size or financial stability.

What is needed, therefore, is an improved system for generating and allowing utilization of quantified leads from architectural information.

### BRIEF DESCRIPTION OF THE DRAWINGS

The drawings and detailed description that follow are intended to be merely illustrative and are not intended to limit the scope of the invention as contemplated by the inventors.

FIG. 1 is a flowchart of a set of high-level steps that a system could perform to generate and manage quantified project leads.

FIG. 2 is a schematic diagram of an exemplary system configured to generate quantified leads from basic project info.

FIG. 3 is a flowchart of a set of steps that a system could perform to receive basic project information from a variety of sources.

FIG. 4 is a flowchart of a set of steps that a system could perform to associate a provisional classification with a project.

FIG. 5 is a flowchart of a set of steps that a system could perform to create and associate a set of tasks with a project.

FIG. 6 is a flowchart of a set of steps that a system could perform to complete tasks for a project takeoff.

FIG. 7 is a flowchart of a set of steps that a system could perform to complete additional tasks for a project takeoff.

FIG. 8 is a flowchart of a set of steps that a system could perform to revise and approve a project takeoff.

FIG. 9 is a flowchart of a set of steps that a system could perform to distribute a completed project takeoff.

### DETAILED DESCRIPTION

The inventors have conceived of novel technology that, for the purpose of illustration, is disclosed herein as applied in the context of generating quantified leads from basic project information. While the disclosed applications of the inventors' technology satisfy a long-felt but unmet need in the art, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

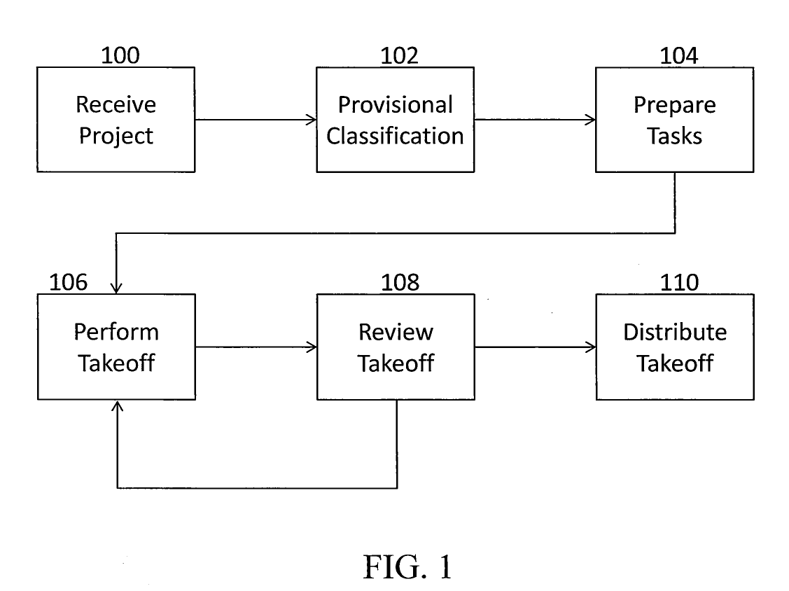

Turning now to the figures, FIG. 1 shows a flowchart of a set of high-level steps that a system could perform to generate and manage quantified project leads. Initially, a set of basic project information may be received (100) by the system via a manual upload from a customer or administrator, by an automated push or pull of one or more sets of basic project information from a third party source, or the like. Basic project information may include one or more blueprints showing structural details of a project such as walls, floors, doors, windows, and similar details. Basic project information may also include details that are provided by the party or service that is providing the information, and may include details such as a project name, geographic location, general contractor name, or similar details that may not be present on a blueprint but may be known by a customer, administrator, or service that is providing the basic information.

In some cases, one or more provisional classifications may be assigned (102). Provisional classifications may be automatically assigned or may be manually assigned, and there may be some overlap between provision classification information and basic project information. For example, some blueprints may have information present on the blueprint that identifies the planned geographical location for the depicted project. This information may be parsed by software configured to extract recognizable information from blueprint image by, for example, optical character recognition conversion and searching of the image, or by identification of watermarks or visual indicators showing the location of parsable data. Manually entered information may be received from a classifier user, who may review the project information at a high level and enter information from the blueprints or other correspondence. Classification information, whether entered manually or automatically, may include such details as a project location, project type, project industry and so on. Provisional classification of the project is useful in order to provide an initial high level classification of the project that may be used to prioritize further processing of the project, or determine a particular path or particular set of users that may act on the project in subsequent steps. For example, if one user or team of users specializes in medical industry projects, while another specializes in education industry projects, a provisional classification may allow for a project to be more accurately routed to a team having specialized knowledge for dealing with such a project.

A project preparer may also create a set of tasks (104) to associate with the project and perform other initial modification of the project information to aid in subsequent analysis. This could include, for example, excluding images from a set of blueprints that will not be relevant for the quantified lead generation process, flagging images from a set of blueprints that will be key images for quantified lead generation, creating tasks describing different rooms for which square footage of walls or floors should be determined, creating tasks describing other characteristics of a project that should be determined, verified, or extracted from blueprints, and the like. A set of prepared (104) tasks may then be used by a project takeoff user to perform (106) a project takeoff. A project takeoff is a set of information that may in varying embodiments include a set of blueprints that have been modified to identify individual rooms and room attributes such as floor square footage, wall square footage, ceiling height, a set of materials information showing the estimated materials that will be required for each room and an estimated materials cost (e.g. a number of sheets of drywall required to finish a room and a per sheet cost, a number of gallons of paint required to paint a square footage of wall space and a per gallon cost), and other information on fixtures, materials, building requirements and the like that may be determined from a skilled examination of the basic project information as well as the use of tools for measuring and demarcating rooms.

Once completed, a takeoff may be reviewed (108) so that minor revisions can be made. If such revisions can be made without creating a need for additional revisions or cascading changes throughout the takeoff, the project takeoff may be approved. If a high number of additional changes are required, the project may be refused and returned to the project takeoff user for additional work. Once reviewed and approved, the completed project takeoff may be distributed (110) through a variety of channels. Distribution may occur in different ways depending upon a particular embodiment, but may include distribution via a searchable database, distribution based upon custom subscriber criteria, distribution via social media and third party sites, and other similar distribution channels.

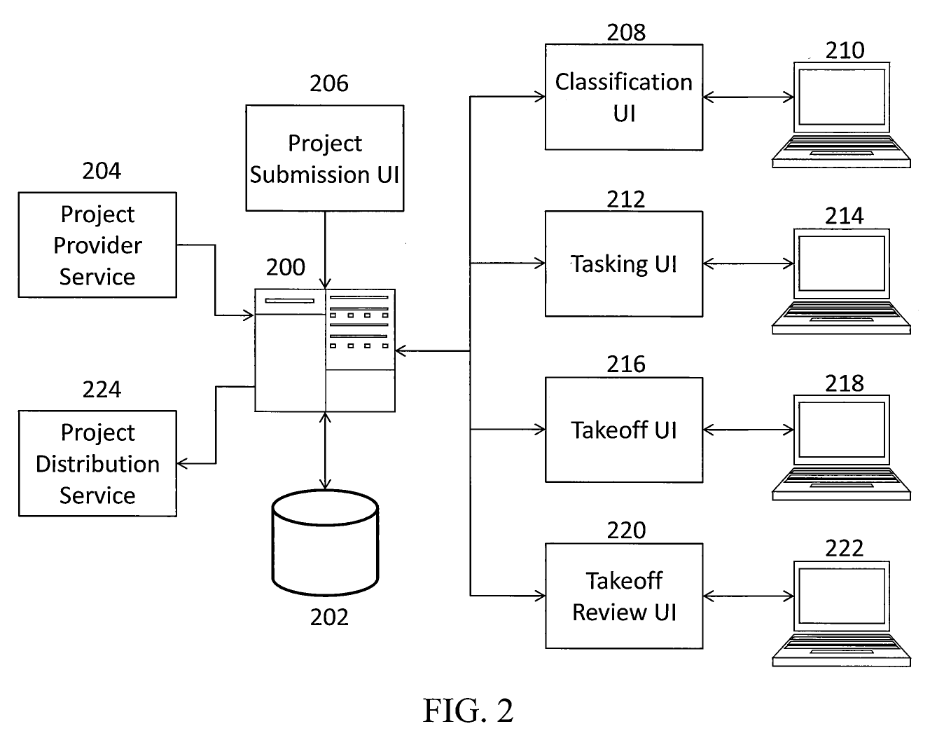

Turning now to FIG. 2, that figure shows a schematic diagram of an exemplary system configured to generate quantified leads from basic project info. A server (200) is communicatively coupled with a database (202). The server may be one or more physical servers, virtual servers, cloud servers, or similar configurations allowing for the receipt, transmission, and manipulation of data. The database (202) may be a local physical database or a remote database hosted in a cloud computing environment, and may be configured to receive, store, and provide data to and from the server (200) using any of a variety of data storing mechanisms such as a relational database, object oriented database, flat file database, or the like. On demand scalability of both the server (200) and database (202) may be advantageous but is not necessary.

A project provider service (204) may be a fully or semi automated service that provides individual or bulk project information from a third party source. For example, this could in some embodiments be a paid subscription to a third party service that pushes one or more sets of basic project information to the server (200) upon an hourly, daily, or similar schedule. Alternately, the server (200) could be configured to pull from the provider service (204) upon a configured schedule. In some embodiments, the provider service (204) and server (200) could be configured to send or request data each time a change in the provider service (204) dataset is detected, or could be configured to exchange data in other similar ways. A project submission UI (206) may be provided in addition to or in the alternative to the project provider service (204). The project submission UI (206) may allow a customer or system administrator to send one or more selected sets of project information to the server (200) so that they may be entered into the system. Data received by the server (200) that originates from either the provider service (204) or submission UI (206) may be in the form of individual files, batched, zipped, or compressed files, or objects (e.g. object oriented programming objects such as an Array, ArrayList, HashMap, or a custom Object), and such received data may be held entirely by the server (200), or partially or completed stored in the database (202) until it may be processed.

Server (200) may be configured to render a number of user interfaces to allow specific functionality to be performed by specific user roles so that a single user is not overwhelmed by the variety of tasks that may be performed. While the user interface shown in FIG. 2 and roles described in relation thereto are not required in every embodiment, the system should ideally have a clear separation of roles in order to maximize the efficiency of the various user roles. A classification UI (208) may be rendered by the server (200) and made available to a classifier user role (210). The classification UI (208) may allow users to perform tasks required in order to provisionally classify (102) a set of basic project information, and may additionally have a messaging or notification capability for a classification queue. A classification queue may be configured to receive sets of project info as they are received (100) by the system. As projects are placed in the classification queue, a classification user (210) will receive an indication via the classification UI (208) that a project is available in the classification queue. This notification may be shown to all classification users, or may be shown to a particular classification user (210), or a particular subset of classification users (210), as may be desirable and configured in differing embodiments.

This could include, for example, configuring projects from a particular source, such as a particular third party project provider service (204) to be placed into a classification queue for classification users (210) who are trained or experienced with projects arriving from that particular provider service (204). Alternately, the system could be configured to manage workloads for multiple classification users (210) so that incoming projects can be evenly distributed across all classification users (210) that are currently logged into the system, for example. The classification queue may further enforce locking of objects in the queue, to prevent multiple classification users (210) from simultaneously selecting the same project from the queue, as well as transactional aspects such as causing a project to revert to a classification queue if it is selected from the queue by a classification user (210) who then disconnects or fails to complete classification of the project.

The server (200) may also render a tasking UI (212), allowing tasking users (214) to perform tasks related to task preparation (104), a takeoff UI (216), allowing takeoff users (218) to perform tasks related to takeoff performance (106), and a takeoff review UI (220), allowing takeoff review users (222) to perform tasks related to takeoff review (108). As with the classification UI (210), each of these user interface may offer messaging and notification for a tasking queue, a takeoff queue, and a takeoff review queue, with each queue offering similar features such as notification of all users or a subset of users when an object is added to the queue, locking of objects in a queue, transactional management of objects in a queue, and other similar functionality. The system may also have a project distribution service (224) for distributing completed and approved project takeoffs. The project distribution service (224) may include interfaces for allowing user searching of databases for project takeoffs meeting specified criteria, interfaces for delivering one or more project takeoffs that meet previously defined criteria to a user as they become available, or interfaces and services for pushing project takeoff data to social media sites and other third party sites as they become available

As mentioned above, the shown organization of user interfaces, user roles, and queues is not strictly required, and there may be some overlap in functionality or combination of roles. As an example of overlap, a drawing and measuring tool for demarcating rooms on a blueprint may be available in both a classification UI (208) and a takeoff UI (216), as initial measurements may be useful both for classification purposes as well as for completing a takeoff. As an example of combined roles, a classification user (210) and a tasking user (214) could be the same user, and the classification UI (208) and tasking UI (212) could, in some embodiments, be combined. However, it should be noted that while some overlap or combination of roles may be useful, the organization of user interfaces and roles disclosed in FIG. 2 and variations thereon are useful in addressing certain technical problems unique to quantified lead generation. For example, an adequate staff for supporting the system shown in FIG. 2 might include hundreds of individual users spread across classification roles (210), tasking roles (214), takeoff roles (218), and takeoff review roles (220). Adding further complexity, certain users may have specialties making them more ideal for some project work than others, such as in the case where a takeoff user specializes in project takeoffs for paint projects but has no experience in plumbing projects. Without systems in place such as functionality limited user interfaces and queues that allow for distribution of workload to those ideally suited for particular projects, locking of projects to prevent concurrency conflicts, and transactional management of projects to prevent lost projects, major sources of inefficiency and error can be introduced, potentially resulting in the overall scope of the system being reduced so as to not become unmanageable.

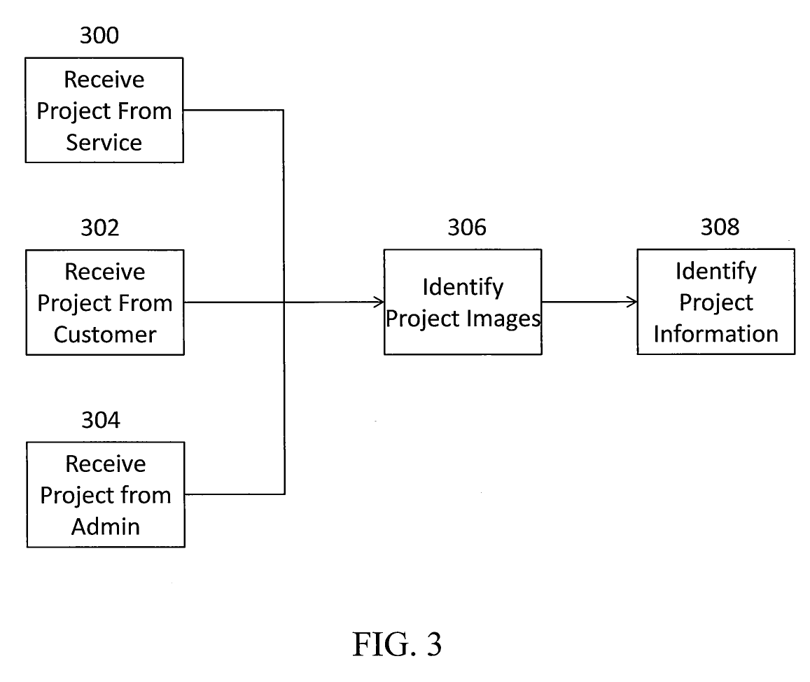

Turning now to FIG. 3, that figure shows a flowchart of a set of steps that a system could perform to receive basic project information from a variety of sources. Basic project information, which may in different variations include both blueprints and high level project information such as project location, project source, project type, or similar characteristics, may be received from a variety of sources. Basic project information may be received from a service (300) such as a third party service provider pushing or allowing to be pulled one or more sets of project information via a project provider service (204) that may be a software interface, web service, email service or the like. Receiving data via a service (300) may occur as data becomes available or upon a configured schedule, or may be triggered by a manual request or transaction triggered by a party. Basic project information may also be received (302) from a customer or received (304) from an administrator or internal user of the system. For example, information may be received (302) from a user when a contractor or project supplier uploads, via a project submission UI (206), a set of blueprints for a project they are involved in and would like to have distributed as a takeoff via the system. Similarly, information may be received (304) from an administrator or internal user of the system when project information is obtained through classic methods such as inquiring with local architects, contractors, or suppliers who are not capable of supporting automated introduction of the project information via a project provider service (204). In such instances, an administrator or internal user may upload one or more projects via the submission UI (206) similar to the way in which a customer wanting a particular project distributed would.

As projects are received from one or more sources (300, 302, 304), the projects may initially need to be unzipped, unencrypted, converted, scanned, or otherwise processed so that they may be mapped to objects recognized by the system. This may include identifying images associated with the project (306) whatever their format may be, as well as mapping these images to objects or formats that the system is able to recognize. For example, in some cases, this may involve identifying a PDF file, extracting one or more pages from the PDF file, and storing the individual pages in a collection object such as an ArrayList or other custom object. Initial receipt of projects may also include identifying project information (308), which may include extracting data from an object sent via a project provider interface (204) and associated with a set of project images, or extracting information from received files. For example, projects arriving via a software interface or web service may arrive as objects and may be bundled with project information. As an example, a custom object ServiceProject may have a first attribute Images, which stores a set of blueprint images, and a second attribute Location, which stores a string descriptor of a future building location for the project. In this case, project images would be identified and extracted (306) from the Images attribute, while other project information would be identified and extracted (308) from the Location attribute. In the case of projects manually added by customers (302) or administrators (304), project information may be identified (308) based upon additional information specified and submitted via text entry elements of a submission UI (206). Alternatively, such additional project information may be embedded in the images themselves and may be identified (308) and extracted via optical character recognition or other methods. Once the components of a received project have been identified (306, 308) it can proceed to a provisional classification step.

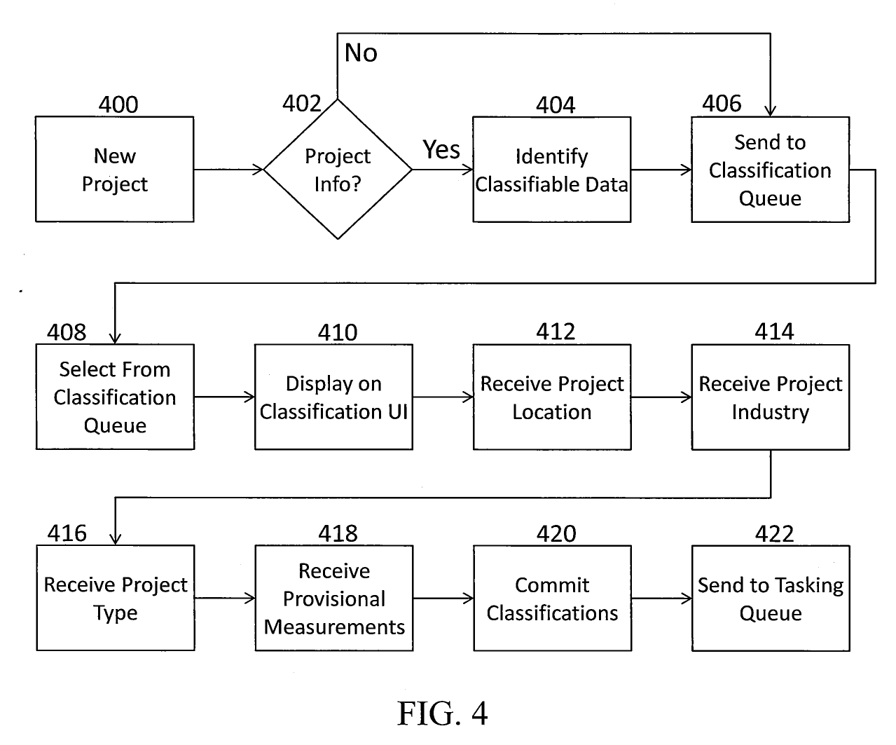

Turning now to FIG. 4, that figure shows a flowchart of a set of steps that a system could perform to associate one or more provisional classifications with a project. After a new project is received (400) by the system as described in the context of FIG. 3, the system will determine if any project info has been associated with the new project (402). If project info has been associated with the project, whether submitted along with the project or extracted via optical character recognition or the like, it may be examined to determine if any of the submitted data may be used to classify the project automatically (404). For example, where a project is received via web service along with data identifying a project location, or where optical character recognition is used to determine a project location from a blueprint image, such data may be used to classify the project automatically (404) as being associated with the identified location (or a region which includes the identified location). Other automatic classification might include project industry, such as health, education, or entertainment, project type, such as painting, drywall, plumbing, electrical, location, associated general contractors, associated suppliers, and similar data. If there is no project info available beyond the blueprints (402), or, after such data has been used to automatically classify the project (404), the project may be sent (406) to a classification queue. As described above in the context of FIG. 2, the classification queue may be a software queue configured to provide notifications via a classification UI (208) to one or more classification users (210) when it contains projects that may require manual classification. When such a user interacts with the classification UI (208) and indicates that they would like to work on a project that has been sent (406) to the classification queue, the project is selected (408) from the classification queue and displayed (410) on that user's classification UI (208). Upon being selected (408) from the classification queue, the queue may be configured to enforce transactional aspects such as locking other users from modifying the project and ensuring that changes to the project are made and committed before removing the project from the classification queue permanently. When the project is displayed (410) on the classification UI (208), the user interface may display the images associated with the project as well as any information that was submitted with the project or extracted from the project.

While displaying (410) the project, a set of tools required for performing the initial classification will be displayed to allow the user a limited ability to interact with the project. These tools may include a set of measuring tools to allow a user to measure the total square footage of a project, as well as tools to enter certain predefined information about the project. However, these tools may not allow the user to add or delete images or permanently modify images, or delete or modify project information that has been automatically entered, for example. Generally, the tools displayed in the classification UI (208) will allow a classification user (210) to add high level data to the project while limiting their ability to impact the project negatively such as by accidentally or erroneously deleting images or information. While displaying (410) the project on the classification UI (208) the system may receive manually entered information such as a project location (412), project industry (414), and project type (416), if such information is apparent from viewing images from the set of blueprints, or from a deeper review of other information associated with the project. The system may also receive provisional measurements (418), which may be high level measurements that can be accomplished quickly using a limited measurement tool set. For example, the received provisional measurements (418) may be limited to total square footage of an entire project rather than square footage of interior rooms of a project, or linear footage of the exterior walls of a project. While certain steps (412 414, 416, 418) are shown in a particular series, it should be understood that these may be performed in any order, if they are performed at all, as each may in different embodiments be optional. Once automatic and manual classifications have been identified and received, a classification user (210) may review and commit (420) such classifications, causing the project and any associated data objects or database entries to be updated to reflect the additional classifications. Once a project has been classified, it may be sent (422) to the tasking queue.

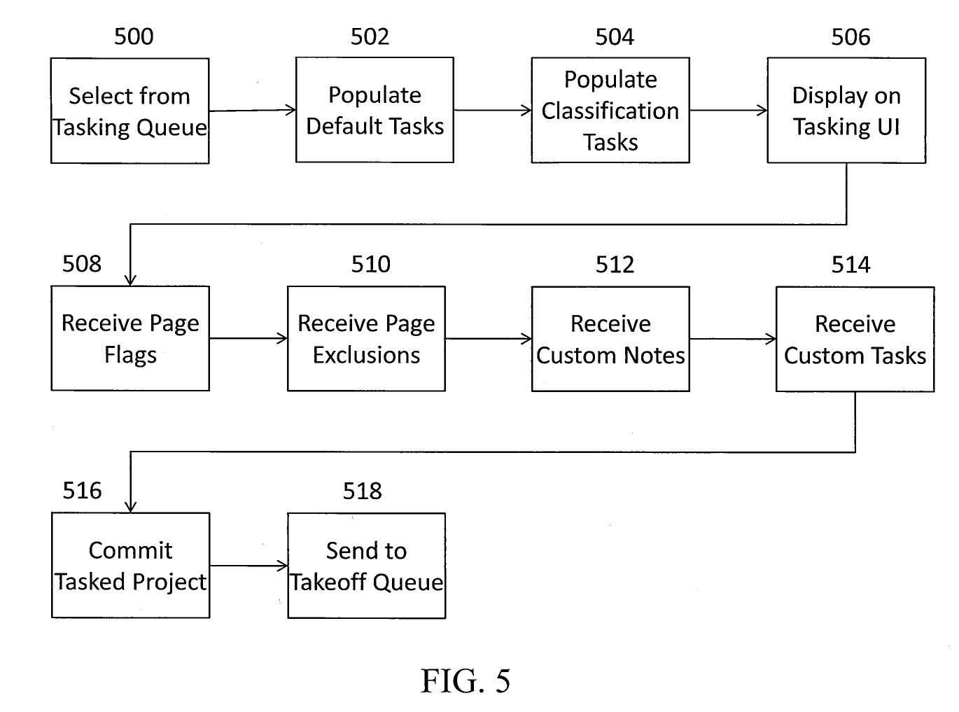

Turning now to FIG. 5, that figure shows a flowchart of a set of steps that a system could perform to create and associate a set of tasks with a project. When a project has been placed into the tasking queue, a notification may be generated via the tasking UI (212) indicating to a tasking user (214) that a project is ready to be tasked. As with other queues, the tasking queue may be configured to notify all tasking users, a single tasking user, or a subset of tasking users as may be advantageous. For example, if a particular tasking user has more experience in preparing and creating tasks for projects involving painting, a project that has been classified as being a painting project may be routed to that particular tasking user. When a tasking user is able to work on a project that has been placed in the tasking queue, they may interact with the tasking UI (212) to cause the project to be selected (500) from the tasking queue. As with the use of all queues disclosed herein, selection (500) from the tasking queue may result in a locking of the object to prevent concurrency issues as well as a transactional hold on the object until confirmation is received that the object was fully processed and may be permanently removed from the queue. After selecting a project from the tasking queue (500), some tasks may be automatically created. In some cases, one or more default tasks may be created (502). Default tasks are tasks that will be created for a project in all or nearly all cases. For example, one default task may to determine wall or ceiling height for a structure depicted in a blueprint page. Another default task may be to verify that blueprints are present for each floor of a multi-floor structure depicted in the blueprints. Another default task may be to determine the square footage of the entire structure, or a square footage of each room in the structure. Classification based tasks may also be automated populated (504) based upon classifications that have been associated with a particular project. For example, if a project has been associated with a state or city that is in an area prone to flooding, a classification based task may be to select water resistant materials to be used in determining materials cost and usage. As another example, if a project has been associated with a painting job type, a classification based task may be to determine a total number of gallons of paint required for each room on each blueprint page.

Once any tasks have been automatically populated, the project may display (506) on the tasking UI (212). When displaying (506) on the tasking UI (212), the project images and project information may be displayed to a tasking user (214), as well as any automatically populated tasks. Additionally, the tasking UI (212) may have tools allowing a tasking user (214) to browse through pages of images from a set of blueprints, browse through project information, flag pages to be excluded, flag pages as important, create, remove and modify tasks and notes, and similar functionality. The tasking UI (212) may not have measuring tools or drawing tools, or may only have a limited set of measuring tools. The tasking UI (212) may also offer a messaging capability for receiving questions from a takeoff user (218) via the takeoff UI (216), to allow a takeoff user (218) to route questions associated with a project to the tasking user (214) that prepared and tasked that project. The system may receive, via the tasking UI (212), one or more of a set of page flags (508), a set of page exclusions (510), a set of custom notes (512), or a set of custom tasks (514), in any order. Received page flags (508) may indicate one or more pages from amongst a set of blueprint pages that the tasking user (214) considers to be of importance or relevance in creating the project takeoff. For example, a certain set of blueprints may contain several overhead elevation views of a first floor of a building, as well as side elevation views, perspective views, and the like. The tasking user (214) may flag a single overhead elevation view as being the best view for a subsequent takeoff creation. Received page exclusions (510) may indicate one or more pages from amongst a set of page exclusions (510) that the tasking user (214) considers to be of no use in a subsequent takeoff creation. In the example above, the tasking user (214) may flag several of the overhead elevation views, as well as the side elevation and perspective views as being excluded for the subsequent takeoff. Received custom notes (512) may be factors that the tasking user (214) would like a takeoff user (218) to consider when performing the takeoff, but which may not raise to the level of a task.

Custom notes may be placed in a general list of tasks, or may be placed on a specific location on the map to call attention. For example, a custom note may be placed in a general list instructing a takeoff user (218) to ignore all bathrooms and closets on one or more pages of a set of blueprints. Alternately, a custom note may be placed on a specific location of a blueprint instructing a takeoff user (218) to ignore a specific room, or calling out an error on a blueprint such as a missing wall or missing door. Custom tasks may include any task that the tasking user (214) would like to enter that is not automatically populated. For example, when populating default tasks (502), imaging software may be used to identify individual rooms and create tasks for measuring and demarcating those rooms. However, if automated tasking of rooms is inaccurate or incomplete, the system may receive custom tasks (514) identifying additional rooms. As another example, a received custom task (514) may be to determine material amounts and expense estimates, determine fixture amounts and expense estimates, or determine if other custom criteria are met, such as whether a certain project as depicted on a blueprint qualifies for state or local subsidies for contracts based upon placement of wheelchair access or other similar characteristics.

Once a tasking user (214) is satisfied that all requires tasks have been created and pages have been flagged or excluded, the tasking user may, via the tasking UI (212), commit the tasked project (516) causing the project and any associated data objects and database entries to be updated to reflect the tasks now associated with the project. Once committed, the project may be sent (518) to the takeoff queue. Commitment of the project (516) may also unlock the object within the tasking queue and signal the completion of the transaction, allowing the object to be permanently removed from the queue.

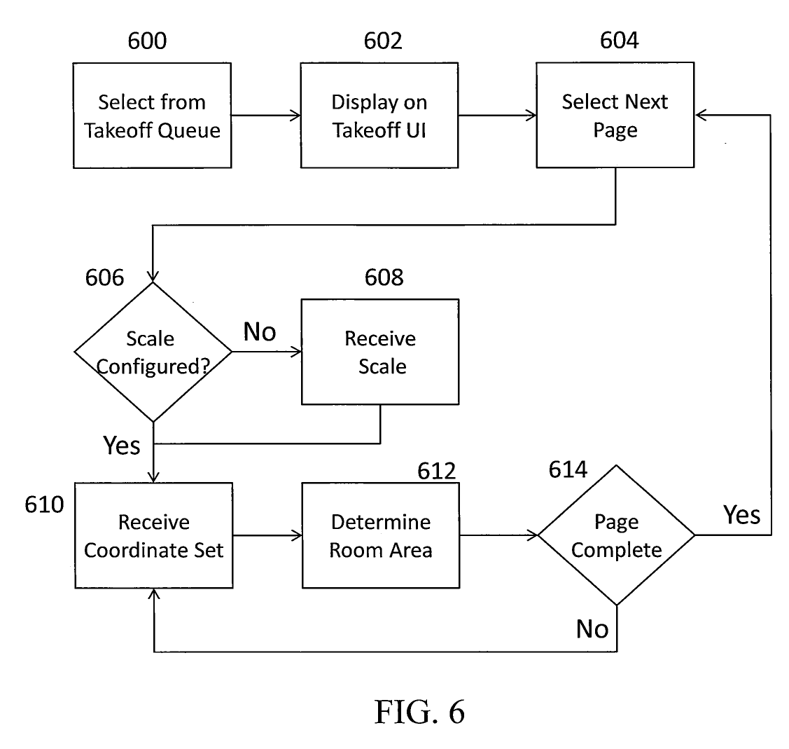

Turning now to FIG. 6, that figure shows a flowchart of a set of steps that a system could perform to complete tasks for a project takeoff. When a project is placed in the takeoff queue, a notification may be delivered via the takeoff UI (216) to a takeoff user (218) indicating that a project is available. The takeoff UI (216) may be used to select (600) a project from the takeoff queue and display (602) the project via the takeoff UI (216). As with other queues disclosed herein, the takeoff queue may support object locking and transactional handling of projects to prevent concurrency errors and lost projects. When displayed (602) via the takeoff UI, blueprint pages that were marked as excluded during the tasking phase will not be viewable, while blueprint pages that were flagged as important may be prioritized to the front of the set of blueprint pages to indicate that they are likely the best views to use when creating the takeoff. The takeoff UI (216) will offer a limited set of tools for interacting with the project, that may include measuring tools, tools for demarcating different rooms on a blueprint page in different colors, tools to identify and set fixtures and materials as well as fixture and material cost, and tools for viewing and marking tasks from a task list as complete. The takeoff UI (216) may also offer a messaging capability so that questions submitted by a takeoff user (218) may be automatically routed to the tasking user (214) that prepared the project that is currently being worked on and create an ongoing dialogue window between the takeoff UI (216) and the tasking UI (212) so that issues related to the project may be resolved.

In some embodiments, the takeoff UI (216) may allow a takeoff user (218) to select a color to associate with the measuring and drawing tools that are used to demarcate rooms, so that the measured outlines of rooms can be drawn in varying colors. These colors may be configured via the tasking UI (212) for each project so that each color may be associated with certain characteristics. For example, if a single blueprint page has one set of rooms that will be finished with ½ inch drywall, and one set of rooms that will be finished with ¾ inch drywall, a first color can be associated with ½ inch drywall and a second color can be associated with ¾ inch drywall. If these colors are configured in advance, these colors can be selected via the takeoff UI (216) when marking a blueprint in order to help the takeoff user (218) in selecting or estimating materials at a later time, or, in some embodiments, the selection of a specific color to mark the edges of a room may cause an automatic selection and estimation of materials for that room based upon the materials that were earlier associated with the color. This association between a marking color and a material could be applied to paint, floor materials, ceiling materials, and other materials, or may also indicate room specific features such as ceiling height, room type, project type, or the like.

A primary function of the takeoff UI (216) is to allow a takeoff user (218) to determine scale of a blueprint page and to identify coordinates for demarcating and measuring a room. This may be performed by selecting (604) a page from the set of blueprint pages and displaying the page via the takeoff UI (216). If a scale for the page has not been configured (606), the system may receive (608) a scale configuration via the takeoff UI (216). The scale configuration may be determined using a measuring tool of the takeoff UI (216) against a known distance on the blueprint, such as an area of the blueprint where a distance is called out or a scale indicator is provided. This scale configuration may be in the form of, for example, inches per pixel of the image, such that once the scale has been configured the use of a measuring tool across a distance of the image may determine a number of pixels that are traversed by the measuring tool, and subsequently determine a number of inches or feet traversed by the measuring tool.

If the scale has been configured, the system may receive (610) a coordinate set indicating the demarcation points of a room. The system may be configured to receive a variety of coordinate sets, but as an example, the coordinate set may be three or more pairs of x/y coordinates, with each pair of coordinates indicating a single point on the current blueprint page as well as an order indicating which single points are connected. In this embodiment, a coordinate set of ((0,0),(100,100),(200,0)) would result in a triangular room being drawn at the bottom left corner of the image, assuming the grid of pixels is centered on the bottom left of the image, as it could also be centered on the center of the image and allow for negative points on the graph. This is simply one manner in which the system could be configured to receive coordinate sets, and variations or alternatives to the disclosed method will be apparent to one of ordinary skill in the art in light of the disclosure herein. After the coordinate set is received (610), an area for the room may be calculated (612) in square units of measurement using the coordinate set and the configured scale. The process of receiving a coordinate set (610) and determining the area of the room indicated by the coordinate set (612) may repeat any number of times until no more rooms remain on the current blueprint page that must be measured. In some embodiments this may be indicated by the completion of all measurement tasks specific to that page, or, may be indicated simply be the takeoff user's (218) determination that all rooms have been measured. When it is determined that the page is complete (614), a next page from the set of blueprint pages be selected (604), and the steps of setting a scale (606) and determining room area (612) may be repeated for that page and subsequent pages.

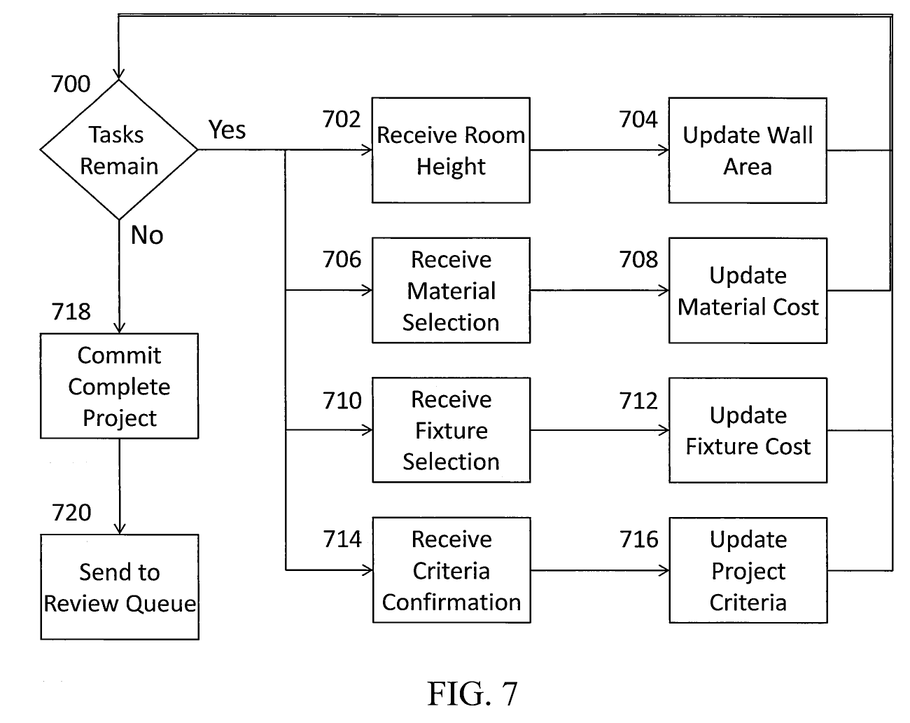

Turning now to FIG. 7, that figure shows a flowchart of a set of steps that a system could perform to complete additional tasks for a project takeoff. Additional tasks may be completed via the takeoff UI (216) concurrently with the completion of room measurements described in the context of FIG. 7. While tasks remain for individual pages of the project or for the project as a whole (700), information may be received via the takeoff UI (216) to complete remaining tasks. Additional tasks could include, for example, receiving (702) a room height for each demarcated room or for the entirety of a page, and updating (704) the takeoff with the area of walls for each room or page where wall height is configured. Wall area may not be required for every project, such as projects where only floor or ceiling work is required, but may be required for projects requiring drywall or paint work. Material selections may also be received (706) for each room or page, and may indicate material use such as sheets of drywall, drywall tape, joint compound, gallons of paint, carpeting, ceiling tiles, or similar materials that may be estimated based upon square footage of walls, ceilings, or floors. Materials costs may also be determined (708) for the project as a whole based upon configured pricing for the selected materials. Fixture selections may also be received (710) for each room or page, and may indicate fixtures required for a room or page such as toilets, sinks, windows, doors, permanent furnishings or decorations, lights, ventilation, and similar fixtures that may be installed during a construction phase for a building. Once fixtures have been selected, a fixture cost may be determined (712) for the project based upon configured pricing for the selected fixtures. Criteria information may also be received (714) for a room or project. Criteria information may define a set of custom criteria that a particular project may be evaluated for. For example, some projects may be located within a historical zoning area and as a result will require special procedures for dealing with construction debris and delivery of materials. A custom criteria task may be manually or automatically created based on the projects geographical location or other markings on the blueprint indicating a possible presence in a historical zoning area. If information is received (714) indicating that the project meets these criteria, as could be confirmed by additional research or communication with local officials, the project may be updated (716) to indicate that the custom criteria have been met, providing an additional searchable aspect of the project that some contractors may find valuable.

Once all tasks have been completed (700), the project takeoff is complete and may be reviewed and committed (718), causing the project and any associated data structures or database entries to update as well. Commitment (718) of the completed project may also complete the transactional aspect of the project's selection from the queue and allow it to be permanently removed from the queue. The project may then be sent (720) to the review queue.

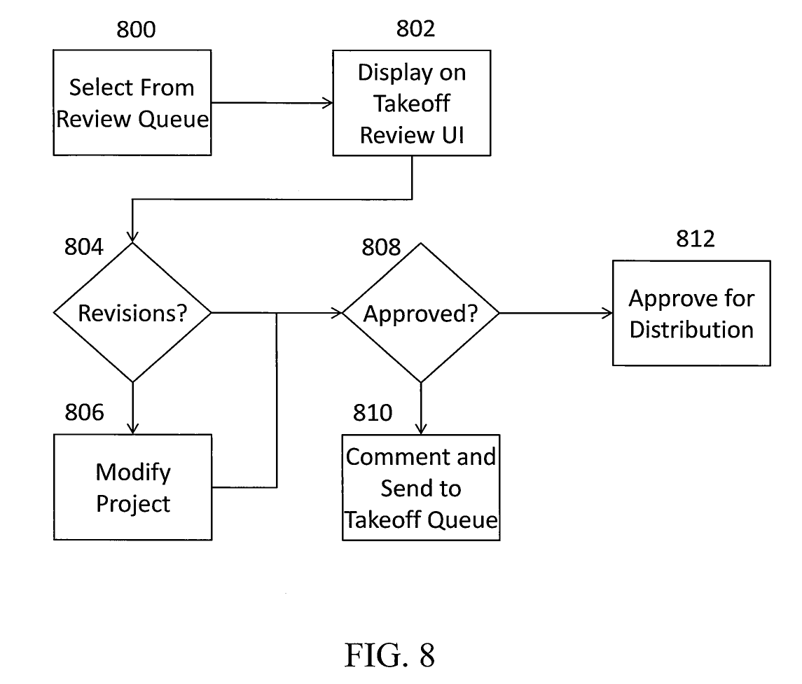

Turning now to FIG. 8, that figure shows a flowchart of a set of steps that a system could perform to revise and approve a project takeoff. A project may be selected (800) from the review queue via the takeoff review UI (220), causing the project to be locked to prevent concurrency issues and enforcing the transactional aspect of the queue. A selected project may be displayed (802) via the review UI (802), causing all project images, including those excluded during tasking, and all project information, tasks, and other associated data to display. The review UI (802) may offer a limited functionality to make minor revisions, such as the ability to modify an existing room measurement, but not create new room measurements, as an example. If the review user (222) determines that revisions to the project are needed (804), minor revisions may be made to modify the project (806). This could include changing an existing measurement, changing the scale of one or more pages, changing wall height for one or more rooms or pages, changing a material selection, changing a material cost, or the like. Generally, the review UI (802) only allows changes to be made that do not require extensive reworking of the project takeoff. Therefore, while the review UI (802) may allow a page scale to be changed, since this is a simple change and the previously calculated room areas can be quickly reworked based upon the modified scale. However, the review UI (802) may not allow a review user (222) to create new measurements for rooms. If no further revisions are needed to the project (804), the review user (222) will determine if the project can be approved or not (808). If the project cannot be approved (808), such as in where one or more rooms were not measured, the review user (222) may flag the rooms or pages affected by the error and the system may send (810) the project back to the takeoff queue with additional tasks or comments so that the error may be corrected. If the project is approved (808), the system may approve (812) the project for distribution, completing the transaction from the review queue and causing or scheduling the completed project takeoff for distribution.

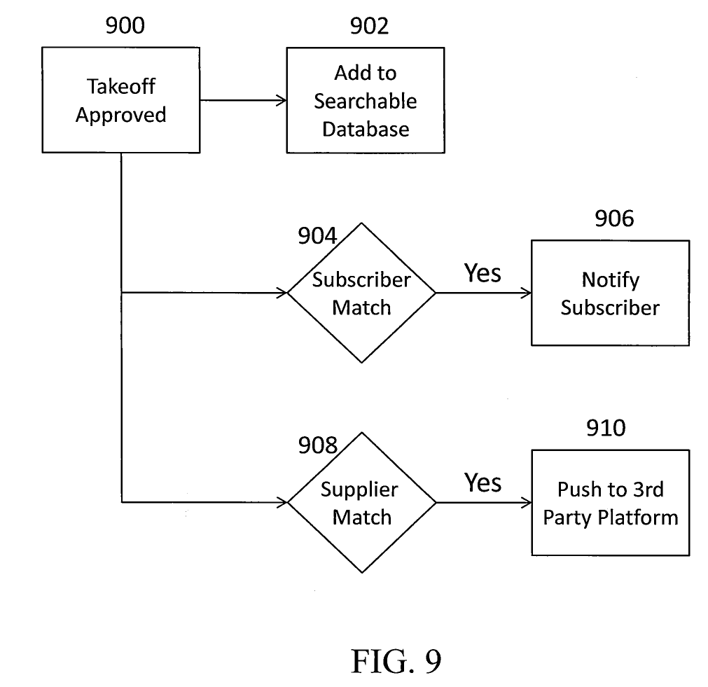

Turning now to FIG. 9, that figure shows a flowchart of a set of steps that a system could perform to distribute a completed project takeoff. Once a takeoff has been fully approved (900) for distribution, it may be distributed via a variety of channels. This may include, for example, being added to a searchable database (902) that may allow end users to search for projects meeting various configurable criteria. For example, projects may be searched by any classification information, such as location, project type, project industry, by number of rooms, by total area of rooms, by total area of walls, by estimated materials and cost, by estimated fixtures and cost, by custom criteria, or by any other information associated with the project that customers may find it advantageous to search by. Projects may also be distributed based upon a subscriber match (904). Subscribers may define criteria for specific types of projects they would like to receive information for. Whenever a project takeoff is approved for distribution, it may be checked against existing subscriber criteria, and where there is a subscriber match the subscriber may be notified (906) via a subscriber interface, email, or other contact method. For example, if a particular subscriber such as a contractor wants to be notified of small local jobs, criteria may be defined so that the subscriber is notified of jobs within a configured mileage of their chosen location that also have an estimated materials cost of less than $2000. Projects may also be distributed based upon a supplier match (908). This could include a large scale supplier of paint and paint supplies defining supplier criteria that will identify large scale painting jobs, so that when a new project takeoff is approved that matches the supplier criteria it may be pushed to 3^{rd} party platforms (910). For example, if a project takeoff is added with paint materials cost exceeding $5000, a supplier configured match may identify the takeoff (908) and cause the takeoff information to be pushed to various social media sites, classified ad sites, or other advertising platforms.

Additional examples and methods of distribution (110) are possible and will be apparent to one of ordinary skill in the art in light of the disclosure herein. For example, as project takeoffs are performed for multiple jobs spread across a large geographical region, certain information may be aggregated for that region as well as sub-regions. For example, material (706) and fixture (710) information received for projects associated with a region could be totaled and provided in response to a request for such information, or as part of a scheduled delivery. In such an example, a paint supplier may subscribe to a service that provides monthly information on the total gallons of paint, paint rollers, masking tape, and other similar materials that contractors may wish to purchase within a certain region in the following months. A region could be, for example, a region such as the Midwest, a State, City, County, proximity to a zip-code, or similar location. Once per month, the system could aggregate all estimated material information received (706) as part of project takeoffs for projects associated with the selected region and provide such information to the supplier via a software interface, electronic communication, paper delivery, or similar channel.

As another example, in a variation of delivery via a searchable database (902), current project takeoff information may be displayed via an interactive web interface in the form of a row oriented list of all project takeoff information that the system currently considers to be still relevant, based upon, for example, a project's date of entry into the system or a project completion date associated with the project indicating it (or, preferably, the process of submitting bids for it) is still underway. Such an interactive web interface could display information associated with the project during the project takeoff in a column association with a project row, and could allow sorting of such information (e.g. sort by most total square footage, sort by highest total material cost, sort by project type), filtering of such information (e.g. only displaying projects of a certain type, only displaying projects under a certain square footage, only displaying projects that are not located within a historical district), previewing of blueprints associated with a selected project within the list, hover over or pop up viewing of blueprints associated with a selected project, and other similar interactive web features.

Further variations on, and features for, the inventors' technology will be immediately apparent to, and could be practiced without undue experimentation by, those of ordinary skill in the art in light of this disclosure. Accordingly, instead of limiting the protection accorded by this document, or by any document which is related to this document, to the material explicitly disclosed herein, the protection should be understood to be defined by the claims, if any, set forth herein or in the relevant related document when the terms in those claims which are listed below under the label “Explicit Definitions” are given the explicit definitions set forth therein, and the remaining terms are given their broadest reasonable interpretation as shown by a general purpose dictionary. To the extent that the interpretation which would be given to such claims based on the above disclosure is in any way narrower than the interpretation which would be given based on the “Explicit Definitions” and the broadest reasonable interpretation as provided by a general purpose dictionary, the interpretation provided by the “Explicit Definitions” and broadest reasonable interpretation as provided by a general purpose dictionary shall control, and the inconsistent usage of terms in the specification or priority documents shall have no effect.

Explicit Definitions

When appearing in the claims, a statement that something is “based on” something else should be understood to mean that something is determined at least in part by the thing that it is indicated as being “based on.” When something is required to be completely determined by a thing, it will be described as being “based exclusively on” the thing.

When used in the claims, “configured” should be understood to mean that the thing “configured” is adapted, designed or modified for a specific purpose. An example of “configuring” in the context of computers is to provide a computer with specific data (which may include instructions) which can be used in performing the specific acts the computer is being “configured” to do. For example, installing Microsoft® WORD on a computer “configures” that computer to function as a word processor, which it does by using the instructions for Microsoft WORD in combination with other inputs, such as an operating system, and various peripherals (e.g., a keyboard, monitor, etc).

When used in the claims, “determining” should be understood to refer to generating, selecting, defining, calculating or otherwise specifying something. For example, to obtain an output as the result of analysis would be an example of “determining” that output. As a second example, to choose a response from a list of possible responses would be a method of “determining” a response. As a third example, to identify data received from an external source (e.g., a microphone) as being a thing would be an example of “determining” the thing.

When used in the claims, a “means for coordinating a classification user, a tasking user, a takeoff user, and a review user to prepare a project data set of the one or more project data sets for distribution” should be understood as a limitation set forth in the form of a means for performing a specified function as provided for in the sixth paragraph of 35 U.S.C. §112 in which the specified function is “coordinating a classification user, a tasking user, a takeoff user, and a review user to prepare a project data set of the one or more project data sets for distribution” and the corresponding structure is a system having physical components such as servers and databases shown in FIG. 2 and described in paragraphs [0021]-[0026], where the servers are programmed to present a project data set to the appropriate user via that user's specialized interface at the appropriate time during the workflow for that project data set (examples provided in FIGS. 4-8 and paragraphs [0029]-[0041]).

When used in the claims, a “set” should be understood to refer to a collection containing zero or more objects of the type that it refers to. So, for example, a “set of integers” describes an object configured to contain an integer value, which includes an object that contains multiple integer values, an object that contains only a single integer value, and an object that contains no integer value whatsoever.

What is claimed is:

1. A system comprising a blueprint server configured to:
a) provide access to a classification interface, a tasking interface, a takeoff interface, and a distribution interface;
b) receive one or more blueprint data sets; and
c) place a blueprint data set of the one or more blueprint data sets in a classification queue;
wherein:
i) the classification interface is operable to cause the blueprint server to retrieve the blueprint data set from the classification queue, receive a set of classification data from a classification user, associate the set of classification data with the blueprint data set, and place the blueprint data set in a tasking queue;
ii) the tasking interface is operable to cause the blueprint server to retrieve the blueprint data set from the tasking queue, associate a set of default tasks with the blueprint data set, receive a set of custom tasks from a tasking user, associate the set of custom tasks with the blueprint data set, and place the blueprint data set in a takeoff queue;
iii) the takeoff interface is operable to cause the blueprint server to:
A) retrieve the blueprint data set from the takeoff queue and display a set of tasks comprising the default tasks and the set of custom tasks;
B) receive a scale selection and a set of room coordinates from a takeoff user and, based upon the scale selection and the set of room coordinates, determine an interior area of a room and associate the interior area with the blueprint data set;
C) receive a material selection from the takeoff user and, based upon the interior area and the material selection, determine a material requirement for the room and associate the material requirement with the blueprint data set; and
D) place the blueprint data set in a distribution queue; and
iv) the distribution interface is operable to cause the blueprint server to retrieve the blueprint data set from the distribution queue, receive an approval indicator from a distribution user, and, in response to the approval indicator, mark the blueprint data set for distribution.

2. The system of claim 1, wherein the blueprint server is further configured to identify a set of blueprint images and a set of blueprint information from the blueprint data set, and, based upon the set of blueprint images and the set of blueprint information, determine at least a portion of the set of classification data.

3. The system of claim 2, wherein the set of classification data comprises three or more of:
a) a blueprint industry;
b) a planned location;
c) a blueprint type; and
d) a provisional measurement.

4. The system of claim 1, wherein the set of default tasks comprises three or more of:
a) determining a blueprint scale;
b) determining a blueprint height;
c) verifying each floor of a multi-floor blueprint;
d) determining area of entire blueprint;
e) determining area of one or more portions of blueprint; and
f) determining a material requirement based upon a blueprint type.

5. The system of claim 1, wherein the takeoff interface is operable to cause the blueprint server to retrieve the blueprint data set from the takeoff queue based upon the takeoff user being associated with one or more of:
a) one or more characteristics of the set of classification data;
b) one or more tasks of the set of default tasks; and
c) one or more tasks of the set of custom tasks.

6. The system of claim 1, wherein the takeoff interface is configured to place the blueprint data set in the distribution queue only after each task of the set of tasks has been completed by the takeoff user.

7. The system of claim 1, wherein the takeoff interface is configured to:
a) display a blueprint image from the set of blueprint data;
b) provide a scale measuring tool operable by the takeoff user to generate the scale selection based upon an interaction with the blueprint image; and
c) provide a room outline tool operable by the takeoff user to generate the set of room coordinates based upon an interaction with the blueprint image.

8. The system of claim 1, wherein the tasking interface is configured to receive an exclusion selection from the tasking user, and, based upon the exclusion selection, remove one or more excluded pages of the blueprint data set from the blueprint data set.

9. The system of claim 1, wherein the blueprint server is further configured to:
a) identify one or more approved blueprints from the one or more blueprint data sets, wherein each of the approved blueprints has been marked for distribution by the distribution interface;
b) for each of the one or more approved blueprints, perform at least one of:
i) add that approved blueprint to a blueprint database, wherein the blueprint database is configured to be searchable by an end user; and
ii) compare that approved blueprint to a set of criteria and, where that approved blueprint satisfies the set of criteria, provide that approved blueprint to a user that configured the set of criteria.

10. The system of claim 1, wherein the blueprint server is further configured to provide access to an end user interface, and wherein the end user interface is configured to display:
a) a set of blueprint images from the blueprint data set;
b) one or more interior areas associated with the blueprint data set; and
c) one or more material requirements associated with the blueprint data set.

11. The system of claim 1, wherein the blueprint server is further configured to enforce a set of concurrency controls on each of the classification queue, the tasking queue, the takeoff queue, and the distribution queue, wherein for each queue the set of concurrency controls prevent concurrency conflicts between a plurality of blueprint server actions affecting that queue simultaneously.

12. The system of claim 1, wherein the blueprint server is further configured to enforce a set of transaction management controls on each of the classification queue, the tasking queue, the takeoff queue, and the distribution queue, wherein for each queue the set of transaction management controls prevent partially completed transactions, wherein a partially completed transaction occurs when the blueprint data set is retrieved from an origin queue by the blueprint server but is never placed in a destination queue.

13. A method comprising:
a) receiving one or more blueprint data sets at a blueprint server;
b) placing a blueprint data set of the one or more blueprint data sets in a classification queue;
c) providing a classification interface to a classification user, wherein the classification interface is operable to cause the blueprint server to retrieve the blueprint data set from the classification queue, receive a set of classification data from the classification user, associate the set of classification data with the blueprint data set, and place the blueprint data set in a tasking queue;
d) providing a tasking interface as a tasking user, wherein the tasking interface is operable to cause the blueprint server to retrieve the blueprint data set from the tasking queue, associate a set of default tasks with the blueprint data set, receive a set of custom tasks from the tasking user, associate the set of custom tasks with the blueprint data set, and place the blueprint data set in a takeoff queue;
e) providing a takeoff interface to a takeoff user, wherein the takeoff interface is operable to cause the blueprint server to:
i) retrieve the blueprint data set from the takeoff queue and display a set of tasks comprising the default tasks and the set of custom tasks;
ii) receive a scale selection and a set of room coordinates from the takeoff user and, based upon the scale selection and the set of room coordinates, determine an interior area of a room and associate the interior area with the blueprint data set;
iii) receive a material selection from the takeoff user and, based upon the interior area and the material selection, determine a material requirement for the room and associate the material requirement with the blueprint data set; and
iv) place the blueprint data set in a distribution queue; and
f) providing a distribution interface to a distribution user, wherein the distribution interface is operable to cause the blueprint server to retrieve the blueprint data set from the distribution queue, receive an approval indicator from the distribution user, and, in response to the approval indicator, mark the blueprint data set for distribution.

14. The method of claim 13, further comprising the step of, at the blueprint server, identifying a set of blueprint images and a set of blueprint information from the blueprint data set, and, based upon the set of blueprint images and the set of blueprint information, determining at least a portion of the set of classification data.

15. The method of claim 13, wherein the blueprint data set is retrieved from the takeoff queue based upon the takeoff user being associated with one or more of:
a) one or more characteristics of the set of classification data;
b) one or more tasks of the set of default tasks; and
c) one or more tasks of the set of custom tasks.

16. The method of claim 13, wherein the blueprint data set is placed in the distribution queue only after each task of the set of tasks has been completed by the takeoff user.

17. The method of claim 13, wherein the takeoff interface is further operable to cause the blueprint server to:
a) display a blueprint image from the set of blueprint data;
b) provide a scale measuring tool operable by the takeoff user to generate the scale selection based upon an interaction with the blueprint image; and
c) provide a room outline tool operable by the takeoff user to generate the set of room coordinates based upon an interaction with the blueprint image.

18. The method of claim 13, further comprising the step of enforcing a set of concurrency controls on each of the classification queue, the tasking queue, the takeoff queue, and the distribution queue, wherein for each queue the set of concurrency controls prevent concurrency conflicts between a plurality of blueprint server actions affecting that queue simultaneously.

19. The method of claim 13, further comprising the step of enforcing a set of transaction management controls on each of the classification queue, the tasking queue, the takeoff queue, and the distribution queue, wherein for each queue the set of transaction management controls prevent partially completed transactions, wherein a partially completed transaction occurs when the blueprint data set is retrieved from an origin queue by the blueprint server but is never placed in a destination queue.

20. A system comprising:
a) a blueprint server configured to receive one or more blueprint data sets;
b) a means for coordinating a classification user, a tasking user, a takeoff user, and a distribution user to prepare a blueprint data set of the one or more blueprint data sets for distribution;
wherein the blueprint server is configured to distribute the blueprint data set after the blueprint data set is approved for distribution.
